(19) United States
(12) Patent Application Publication
(10) Pub. No.: US 2014/0164647 A1
(43) Pub. Date: Jun. 12, 2014

(54) Management Data Input/Output (MDIO) Protocol Including Checksum Mode

(71) Applicant: BROADCOM CORPORATION, Irvine, CA (US)

(72) Inventor: Whay Sing LEE, Milpitas, CA (US)

(73) Assignee: Broadcom Corporation, Irvine, CA (US)

(21) Appl. No.: 13/708,376

(22) Filed: Dec. 7, 2012

(51) Int. Cl. G06F 13/38

(52) U.S. Cl. CPC G06F 13/385
USPC 710/4; 710/30

(57) ABSTRACT

A process to manage data between one or more MDIO manageable devices situated on the same bus utilizing the MDIO protocol. The data management efficiency can be increased through the use of an MDIO protocol that includes a checksum mode. The MDIO protocol including the checksum mode can provide write confirmations while reducing the overhead for confirmed write operations by omitting read-back and compare sequences following write transactions.

### CROSS REFERENCE TO RELATED APPLICATIONS

This patent application makes reference to U.S. patent application Ser. No. 13/628,640, filed Sep. 27, 2012 and U.S. patent application Ser. No. 12/049,904, filed Mar. 17, 2008, each of which is incorporated herein by reference in its entirety.

### FIELD

This application relates generally to the management data input/output (MDIO) protocol, and more particularly to the MDIO protocol including a checksum mode.

### BACKGROUND

Ethernet communications provide high speed data communications over a communications link between two communications nodes that operate according the Institute of Electrical and Electronics Engineers (IEEE) 802.3 Ethernet Standard. Ethernet communication environments may utilize a management data input/output (MDIO) bus interface defined by the IEEE 802.3ae standard to manage Ethernet devices included in the Ethernet communication environment.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a block diagram of an MDIO bus interface according to an exemplary embodiment of the present disclosure.

FIG. 2 illustrates a conventional MDIO communication frame format.

FIG. 3 illustrates a block diagram of an MDIO manageable device according to an exemplary embodiment of the present disclosure.

FIG. 4 illustrates a block diagram of an MDIO manageable device according to an exemplary embodiment of the present disclosure.

FIG. 5 illustrates a block diagram of an MDIO manageable device according to an exemplary embodiment of the present disclosure.

FIG. 6 illustrates a flowchart of a method of data management utilizing the MDIO protocol according to an exemplary embodiment of the present disclosure.

FIG. 7 illustrates a block diagram of an exemplary computer system that can be used to implement aspects of the present disclosure.

The embodiments of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details.

Management data input/output (MDIO) bus interfaces are defined by the IEEE 802.3ae standard, and can be utilized to manage Ethernet devices within an Ethernet communication environment. The IEEE 802.3ae standard is incorporated herein by reference in its entirety. Generally, the MDIO interface includes a two-wire bus, one wire for a management data clock (MDC) signal, and another wire for a bidirectional MDIO data signal. Each MDIO interface uses a management device to manage several MDIO manageable devices situated on the same bus.

When the management device is communicating with a MDIO manageable device, the management device can drive the management data clock signal and the MDIO signal. Similarly, a selected MDIO manageable device can drive the MDIO data signal when the MDIO manageable device is providing data to the management device.

The Ethernet communication environment may be described with reference to an Open Systems Interconnect network model (OSI model). The OSI model is an abstract description for layered communications in an Ethernet communication environment, and typically includes seven primary layers. Each of the layers includes a collection of conceptually similar functions, and provides services to an adjacent upper layer and receives services from an adjacent lower layer.

The lowest three layers of the OSI model include the physical layer (layer 1), the data link layer (layer 2) and the network layer (layer 3). The physical layer defines electrical and physical specifications for devices, including a relationship between a device and a physical medium. The data link layer provides for the transfer of data between network entities and error correction. The network layer provides for the transfer of variable length data from a source to a destination via one or more networks.

As mentioned above, the MDIO interface includes a two-wire bus that is used to manage physical layer devices (e.g., MDIO manageable devices). The management of these physical layer devices is based on the access and modification of their various registers.

The MDIO interface can utilize media access control (MAC), which provides a data communication protocol and is a sub-layer within the data link layer. In conventional network models, physical layer devices can communicate with management devices (e.g., CPUs) via a serial management interface such as the MDIO protocol.

The MDIO management device (operating as a MDIO master) of the MDIO interface may include a central processing unit (CPU) that can issue a write command and data to be written to a MDIO manageable device (operating as a MDIO slave) via the MDIO bus. Upon completion of the write command, the MDIO manageable device can provide the MDIO manageable device with a confirmation or completion acknowledgement via the MDIO bus. Additionally, the MDIO management device (MDIO master) can verify the data written by the previously completed write command by issuing a read command including the address associated with the previous write command. For the purpose of this discussion, a write command followed by a successive read command can be referred to as a “read-back and compare” operation.

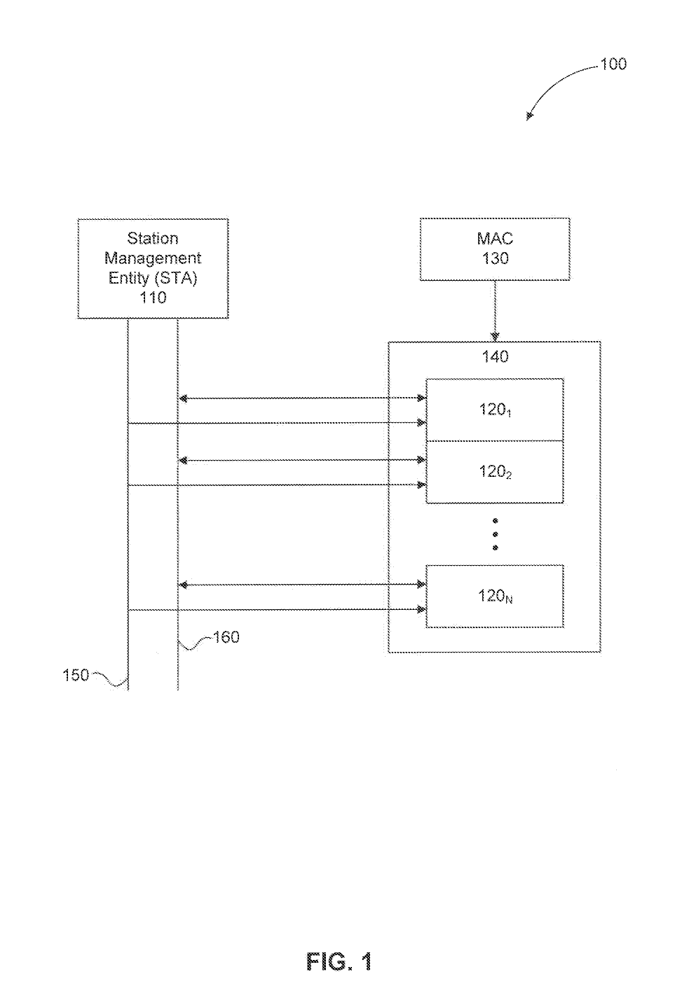

FIG. 1 illustrates a block diagram of an MDIO bus interface 100 according an exemplary embodiment of the present disclosure. The MDIO bus interface 100 can include two signal lines: a management data clock (MDC) signal line 150 and an MDIO signal line 160.

As defined in the IEEE 802.3ae standard, a management device of an MDIO communication environment is referred to as a station management entity (STA) 110 and the slave devices are referred to as MDIO manageable devices 120₁-120_{N}. The station management entity 110 can be configured to control overall operation and/or configuration of the MDIO bus interface 100. For example, the station management entity 110 can initiate communications in the MDIO bus interface 100, and is responsible for driving a management data clock on the management data clock signal line 150.

The station management entity 110 can initiate a command using an MDIO frame, which can include a target register address(es) of one or more of the MDIO manageable devices 120₁-120_{N}. During a write command, the station management entity 110 can also provide the data to a designated register of a target MDIO manageable device 120. In the case of a read command, the target MDIO manageable device 120 can control the MDIO bus line and can supply the station management entity 110 with data read from the target MDIO manageable device 120. The MDIO manageable device 120 can be configured to store data in, and retrieve stored data from, registers. The retrieved data from the registers can be provided to the station management entity 110 via the MDIO signal line 160. Further, as illustrated in FIG. 1, the media access control (MAC) 130 can be coupled to the MDIO manageable devices 120₁-120_{N} to facilitate interaction with the MDIO manageable devices 120₁-120_{N} in the physical layer 140.

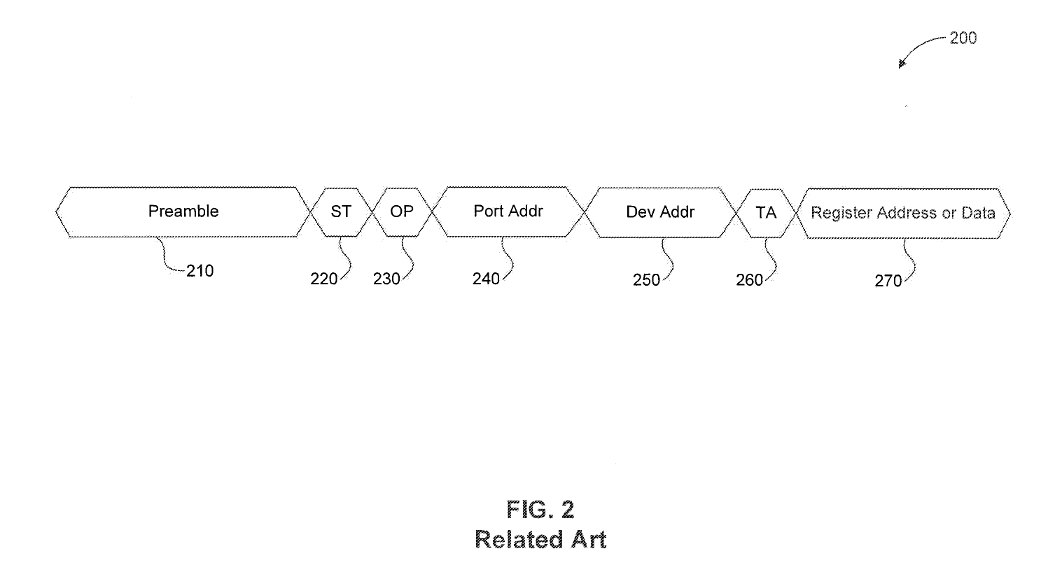

FIG. 2 illustrates a conventional MDIO communication frame format 200. With reference to Table 1, the MDIO communication frame format 200 can include: a preamble 210, a start-of-frame (ST) 220, an operational (OP) code 230, a port address 240, a device address 250, a turnaround time (TA) 260, and an address/data block 270.

TABLE 1

| Reference Symbol | Portion of Frame | Number of Bits | |
|---|---|---|---|
| Preamble | Preamble | 32 | bits |
| ST | Start of Frame | 2 | bits |
| OP | OP Code | 2 | bits |
| PORTADDR | Port Address | 5 | bits |
| DEVADDR | Device Address | 5 | bits |
| TA | Turnaround Time | 2 | bits |
| ADDR/DATA | Address or Data | 16 | bits |

The MDIO communication frame format 200 as illustrated in FIG. 2 can be referred to as an extended MDIO frame format, and is defined in Clause 45 of IEEE 802.3ae. This frame format is an improvement over the original frame format as defined in Clause 22 of IEEE 802.3. The Clause 22 format limits the number of registers and physical devices that could be accessed using the frame format. In particular, the Clause 22 format can be used to access 32 registers in 32 different physical devices. The extended MDIO frame format (Clause 45) provides for faster transaction speeds as well as the ability to access more destinations. In particular, the extended frame format may access up to 65,536 registers, in 32 different physical devices, on 32 different ports.

Using the extended MDIO frame format, the MDIO communication protocol utilizes two transactions to access each register. First, a frame representing an address transaction is sent to specify the target MDIO manageable device 120 and the register within the target MDIO manageable device 120. For example, in an address transaction, the address/data block 270 includes the address of a register within the target MDIO manageable device 120. A second frame is then sent to perform the read or write transaction. During a read or write transaction, the address/data block 270 includes the data that has been read from the register specified by the address transaction, or the data to be written at the destination address, respectively. By utilizing two transactions, the extended frame format (Clause 45) is backwards compatible with the original MDIO frame format (Clause 22).

The extended MDIO frame format is identified using the start-of-frame (ST) portion 220 of the frame. In particular, the value of the ST code 220 is set as “00,” which identifies Clause 45 data frames, while the original MDIO frame format (Clause 22) is identified with a ST code 220 having the value of “01.”

Similarly, the value of the OP code 230 of the extended MDIO frame format identifies the current transaction to be performed. For example, the various transactions and corresponding OP code values are as follows: ADDRESS (00), WRITE (01), READ (11), and a READ-AND-INCREMENT-ADDRESS (READ-INCREMENT) (10).

In operation, one bit is driven onto and/or captured from the MDIO signal line on each management data clock rising edge. Each MDIO transaction is initiated by the preamble 210 (e.g., a fixed 32-bit pattern), followed by a 2-bit start-of-frame (ST) pattern 220. A 2-bit OP code 230 then follows, indicating the current transaction type as discussed above. For example, the ADDRESS transaction is used to latch a register address into the target MDIO manageable device 120. This latched register address identifies the internal control and/or status register that is affected by subsequent WRITE, READ, and READ-INCREMENT transactions targeting the targeted MDIO manageable device 120.

The targeted MDIO manageable device 120 is identified by a 5-bit port address 240 and a 5-bit device address 250 following the OP code 230. Then, a 16-bit register address, or 16-bit register data 270, is driven on to the MDIO signal line by the station management entity 110 in the case of an ADDRESS transaction, or a WRITE transaction, respectively. In the case of a READ or READ-INCREMENT transaction, 16-bits of requested data are driven on to the MDIO signal line by the responding MDIO manageable device 120.

In an exemplary embodiment of the present disclosure, in addition to the above transactions determined by the OP code 230, the station management entity 110 and the MDIO manageable devices 120₁-120_{N} can be configured to perform a page-write mode as discussed in detail in U.S. patent application Ser. No. 13/628,640, filed Sep. 27, 2012, and/or be configured to automatically increment the register address and/or perform a broadcast/multicast operation as discussed in detail in U.S. patent application Ser. No. 12/049,904, filed Mar. 17, 2008.

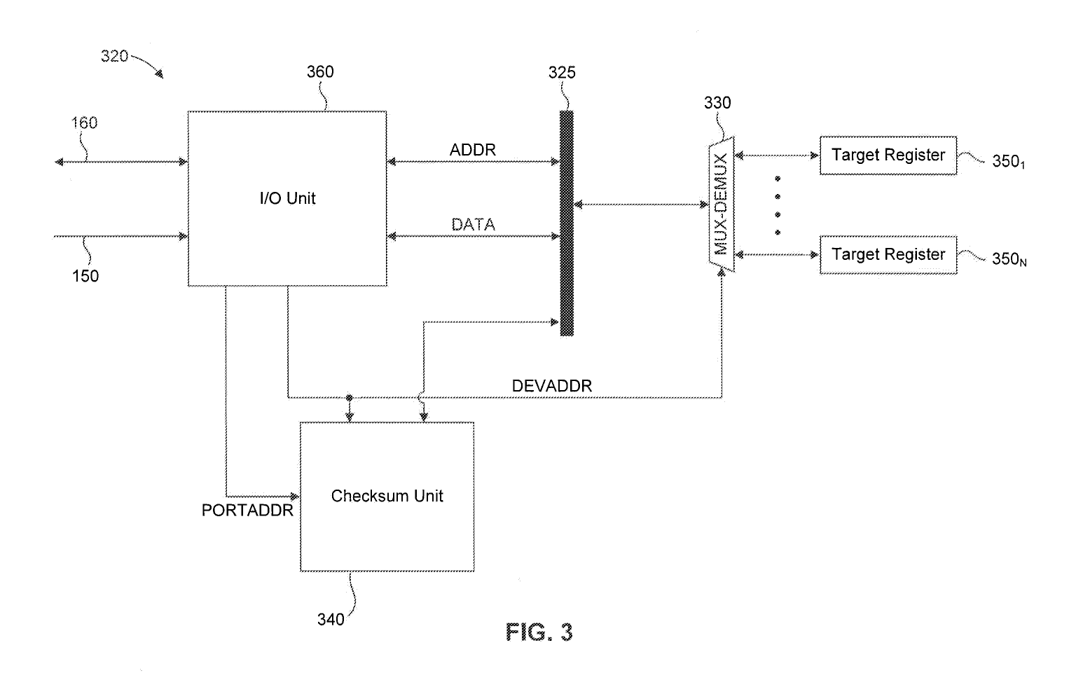

FIG. 3 illustrates a block diagram of a MDIO manageable device 320 configured to generate one or more checksums according an exemplary embodiment of the present disclosure. The generated checksum(s) can be used to detect errors that may have been introduced during the transmission and/or storage of information. The integrity of the information can be checked at a later time by re-computing the checksum and comparing it with a predetermined checksum. The predetermined checksum may be computed by, for example, the creator of a particular data sequence and provided to the user who subsequently implements the data sequence utilizing the MDIO protocol. For example, the predetermined checksum can be computed by a manufacture of a set of computer executable instructions that produce a particular data sequence. Using this predetermined checksum, a user of the computer executable instructions can verify the integrity of the data sequence produced following the execution of the computer executable instructions by the user. The MDIO manageable device 320 can represent an exemplary embodiment of one or more of the MDIO manageable devices 120₁-120_{N}.

The MDIO manageable device 320 can include suitable logic, circuitry, and/or code that can be configured to store data in, and retrieve stored data from, registers of the MDIO manageable device 320 based on the contents of a received extended MDIO frame illustrated in FIG. 2. In particular, the MDIO manageable device 220 can include a multiplexer-demultiplexer 330, a checksum unit 340, target registers 350₁-350_{N}, and input/output (I/O) unit 360.

The I/O unit 330 can be configured to receive a MDIO frame from the station management entity (STA) 110 and provide information contained within the received MDIO frame (e.g., ADDR, DATA, DEVADDR, and/or PORTADDR) to the various components of the MDIO manageable device 320 (e.g., the multiplexer-demultiplexer 330, checksum unit 340, and/or target registers 350₁-350_{N}). The I/O unit 330 can also be configured to receive information from any of the various components of the MDIO manageable device 320 and provide the received information to the station management entity (STA) 110. Further, the I/O unit 330 may communicate with the various components of the MDIO manageable device 320 via a data bus 325.

The multiplexer-demultiplexer 360 can be configured to receive multiple input signals and forward a selected input to a single output, and to receive a single input signal and output the received signal to a selected output from a plurality of outputs. For example, during a write operation, the multiplexer-demultiplexer 360 (operating as a multiplexer) can receive address (ADDR) and data (DATA) from the I/O unit 330 and selectively output the received address (ADDR) and data (DATA) to one of the various target registers 350₁-350_{N} based on a device address (DEVADDR) received from the I/O unit 330. During a read operation, the multiplexer-demultiplexer 360 (operating as a demultiplexer) can receive data (DATA) stored at an address (ADDR) from one of the various target registers 350₁-350_{N}, which is selected based on a device address (DEVADDR) received from the I/O unit 330, and output the received information to the checksum unit 340 and/or the I/O unit 330.

The target registers 350₁-350_{N} can be configured to store bits of information. For example, each of the target registers 350₁-350_{N} can include one or more flip-flops, where each flip-flop is configured to store one bit of information. For example, the target registers 350₁-350_{N} can be 16-bit registers configured to store the 16-bit address/data block 270 of the MDIO frame. However, the target registers 350₁-350_{N} should not be limited to 16 bits, and can be any size that will be apparent to those skilled in the relevant art(s) without departing from the spirit and scope of the present disclosure. Further, in an exemplary embodiment of the present disclosure, the target registers 350₁-350_{N} can be embodied as memory, including, for example, random access memory (RAM), flash memory, and/or any memory that will be apparent to those skilled in the relevant art(s) without departing from the spirit and scope of the present disclosure.

The checksum unit 340 can be configured to generate a checksum utilizing a checksum algorithm and based on an address (ADDR), data (DATA), device address (DEVADDR), and/or port address (PORTADDR) received from a station management entity (STA) 110 during a write operation.

In an exemplary embodiment of the present disclosure, the generation of checksum values by the checksum unit 340 can be enabled based on an enable bit stored in a register. For example, when the enable bit has the value “0,” the checksum unit 340 can be disabled. Conversely, when the enable bit has the value “1,” the checksum unit 340 can be enabled. The enable bit value can be used to reset the value of a previously generated checksum. That is, the checksum unit 340 can be configured to reset the value of the generated checksum upon the disablement of the checksum unit 340. The value of the enable bit can be set by, for example, a signal from the station management entity (STA) 110, and/or an external signal supplied to the MDIO manageable device 320 from a device other than the station management entity (STA) 110.

For example, the checksum unit 340 can be configured to generate checksums while the enable bit has a value of “1.” Upon the enable bit being set to “0,” the value of the generated checksum can be reset (e.g., the checksum value can be set to have a value of all zeros or all ones).

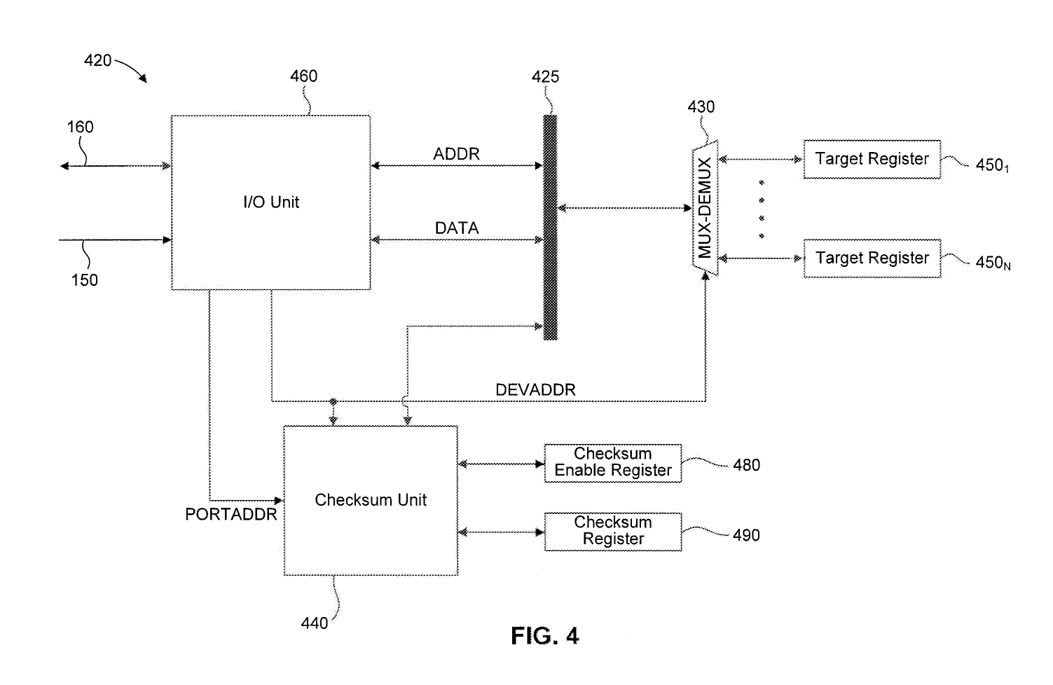

In an exemplary embodiment of the present disclosure, one of the target registers 350₁-350_{N} of the MDIO manageable device 320 can function as a checksum enable register. Further, as discussed in more detail below with reference to FIG. 4, the MDIO manageable device 320 can include a checksum enable register, which can be configured to store an enable bit corresponding to the operating state of the checksum unit 340.

In an exemplary embodiment of the present disclosure, the checksum unit 340 can be configured to communicate with the target registers 350₁-350_{N} via the multiplexer-demultiplexer 360 so as to store the generated checksum in one or more of the target registers 350₁-350_{N}.

For example, the checksum unit 340 can be configured to store a generated checksum in target register 350₁. The checksum unit 340 can then access the checksum stored in the target register 350₁, including during the generation of a subsequent checksum value. Further, as discussed in more detail below with reference to FIG. 4, the MDIO manageable device 320 can include a checksum register, which can be configured to store the value of generated checksum.

In an exemplary embodiment of the present disclosure, the checksum unit 340 can be configured to utilize cyclic redundancy check (CRC). For example, the checksum unit 340 can be configured to utilize the CRC16 algorithm. However, the checksum algorithm should not be limited to CRC16, or CRC in general, and can be any checksum algorithm or data verification process that will be apparent to those skilled in the relevant art(s) without departing from the spirit and scope of the present disclosure.

Although the above discussion describes the generation of a checksum during a write operation, the present disclosure should not be limited to such, and the checksum unit 340 can be configured to generate a checksum during a read operation, read-increment operation, and/or a page-write mode as discussed in detail in U.S. patent application Ser. No. 13/628,640, filed Sep. 27, 2012.

FIG. 4 illustrates a block diagram of a MDIO manageable device 420 configured to generate one or more checksums according an exemplary embodiment of the present disclosure. The MDIO manageable device 420 includes similar components to those discussed above with respect to the MDIO manageable device 320 of FIG. 3. In particular, the MDIO manageable device 420 can include a multiplexer-demultiplexer 430, a checksum unit 440, target registers 450₁-450_{N}, and an input/output (I/O) unit 460, which are similar to the MDIO manageable device 320, the multiplexer-demultiplexer 330, the checksum unit 340, the target registers 350₁-350_{N}, and the input/output (I/O) unit 360, respectively. Therefore, the discussion of these components has been omitted for brevity. The MDIO manageable device 420 can also include checksum enable register 480 and checksum register 490, which are discussed in more detail below.

The checksum enable register 480 can be configured to store one or more bits of information. In particular, the checksum enable register 480 can include one or more flip-flops, where each flip-flop is configured to store one bit of information. For example, the checksum enable register 480 can be a 1-bit register configured to store one bit, where the one bit can correspond to the operating state of the checksum unit 440. The enable bit (e.g., the one bit stored in the checksum enable register 480) can be set by, for example, a signal from the station management entity (STA) 110, and/or an external signal supplied to the MDIO manageable device 420 from a device other than the station management entity (STA) 110.

The generation of checksum values by the checksum unit 440 can be enabled based on the value of the enable bit stored in the checksum enable register 480. For example, when the enable bit has the value “0,” the checksum unit 440 can be disabled. Conversely, when the enable bit has the value “1,” the checksum unit 440 can be enabled. The enable bit value can be used to reset the value of a previously generated checksum. That is, the checksum unit 440 can be configured to reset the value of the generated checksum upon the disablement of the checksum unit 440.

For example, the checksum unit 440 can be configured to generate checksums while the enable bit has a value of “1.” Upon the enable bit being set to “0,” the value of the generated checksum can be reset (e.g., the checksum value can be set to have a value of all zeros or all ones).

Although the above discussion includes a checksum enable register 480 configured to store a single bit of information, and that the enable bit is a single bit, the checksum enable register 480, as well as the enable bit size, should not be limited to one bit, and the checksum enable register 480 and the enable bit can be any bit size that will be apparent to those skilled in the relevant art(s) without departing from the spirit and scope of the present disclosure.

The checksum register 490 can be configured to store one or more bits of information. For example, the checksum enable register 480 can include one or more flip-flops, where each flip-flop is configured to store one bit of information. The checksum unit 440 can be configured to store a generated checksum in the checksum register 490. The checksum unit 440 can then access the checksum stored in the checksum register 490, including during the generation of a subsequent checksum value. By including the checksum register 490, the checksum unit 440 can store and access generated checksums without routing through the multiplexer-demultiplexer 460. Further, in an exemplary embodiment of the present disclosure, the checksum register 490 can be embodied as memory, including, for example, random access memory (RAM), flash memory, and/or any memory that will be apparent to those skilled in the relevant art(s) without departing from the spirit and scope of the present disclosure.

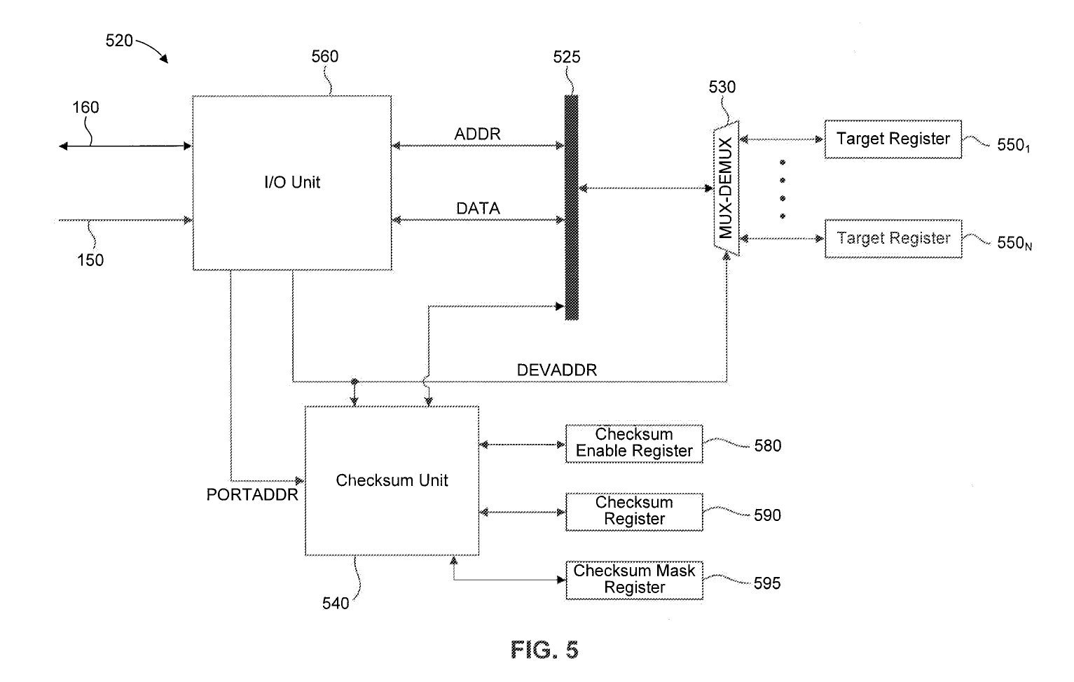

FIG. 5 illustrates a block diagram of a MDIO manageable device 520 configured to generate one or more checksums according an exemplary embodiment of the present disclosure. The MDIO manageable device 520 can include a multiplexer-demultiplexer 530, a checksum unit 540, target registers 550₁-550_{N}, an input/output (I/O) unit 560, a checksum enable register 580, and a checksum register 590, which are similar to the MDIO manageable device 320/420, the multiplexer-demultiplexer 330/430, the checksum unit 340/440, the target registers 350₁-350_{N}/450₁-450_{N}, and the input/output (I/O) unit 360/460 of FIGS. 3 and 4, respectively. Therefore, the discussion of these components has been omitted for brevity. The MDIO manageable device 520 can also include a checksum mask register 595, which is discussed in more detail below.

The checksum mask register 595 can include suitable logic, circuitry, and/or code that can be configured to store one or more bits of information. In particular, the checksum mask register 595 can include one or more flip-flops, where each flip-flop is configured to store one bit of information. The information stored in the checksum mask register 595 can represent checksum mask information that can be utilized by the checksum unit 540 to remove one or more of the inputs used in the generation of checksums by the checksum unit 540. In particular, the checksum unit 540 can be configured to generate a checksum based on a subset selected from an address (ADDR), data (DATA), device address (DEVADDR), and port address (PORTADDR) received from a station management entity (STA) 110. That is, the value stored in the checksum mask register 595 can be used to control which of the various inputs are included in (or excluded from) the generation of the checksum by the checksum unit 540. Further, in an exemplary embodiment of the present disclosure, the checksum mask register 595 can be embodied as memory, including, for example, random access memory (RAM), flash memory, and/or any memory that will be apparent to those skilled in the relevant art(s) without departing from the spirit and scope of the present disclosure.

The value stored in the checksum mask register 595 can be set by, for example, a signal from the station management entity (STA) 110, and/or an external signal supplied to the MDIO manageable device 520 from a device other than the station management entity (STA) 110.

Although the MDIO manageable device 520 discussed above includes checksum mask register 595 to store checksum mask information, the MDIO manageable device 520 can be configured to utilize one or more of the target registers 550₁-550_{N} to store checksum mask information in combination with the checksum mask register 595, or as an alternative to including the checksum mask register 595 in the MDIO manageable device 520.

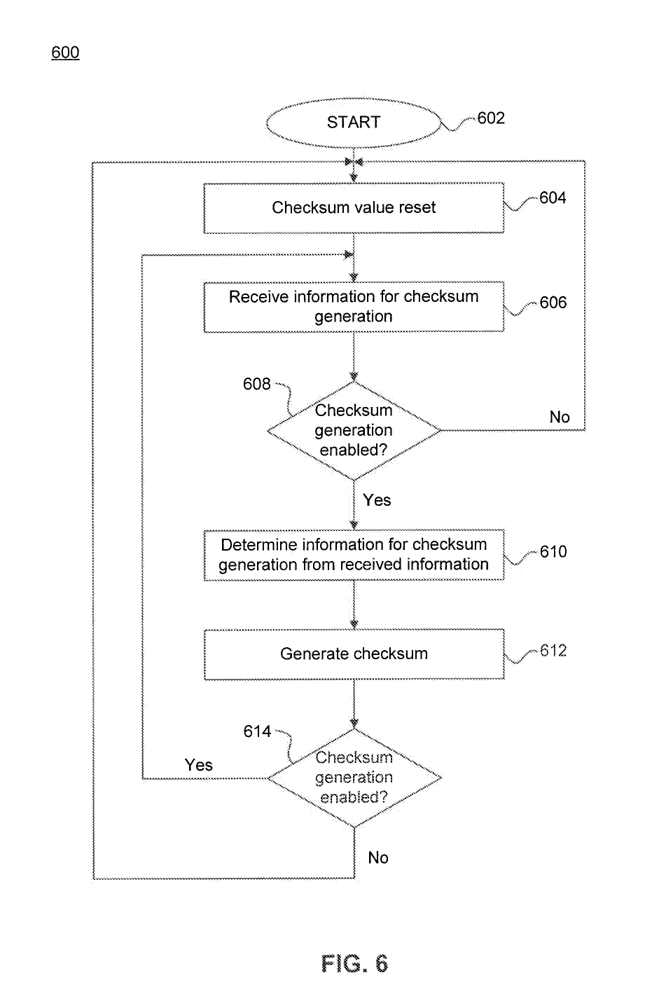

FIG. 6 illustrates a flowchart 600 of a method of generating a checksum utilizing the MDIO protocol in an exemplary embodiment of the present disclosure. The method of flowchart 600 is described with continued reference to FIGS. 1-5. In particular, the exemplary discussion of the method of flowchart 600 makes reference to the various MDIO manageable devices of FIGS. 3-5. It should be appreciated that any discussion of one or more of the MDIO manageable devices 320/420/520 and their respective components can be applied to the other of the MDIO manageable devices 320/420/520 and their respective components.

The method of flowchart 600 begins at step 602 and transitions to step 604, where any previously generated and stored checksum(s) is reset. For example, the checksum unit 440 can reset a previously generated checksum value that is stored in, for example, the checksum register 490, or one or more of the target registers 450₁-450_{N}.

After step 604, the flowchart 600 transitions to step 606, where the checksum unit 440 receives an address (ADDR), data (DATA), device address (DEVADDR), and/or port address (PORTADDR) from the I/O unit 460.

After step 606, the flowchart 600 transitions to step 608, where the checksum unit 440 determines if the generation of checksum values is enabled. If the checksum unit 440 determines that the generation of checksum values is enabled (YES at step 608), the flowchart 600 transitions to step 616. Otherwise (NO at step 608), the flowchart 600 returns to step 604.

For example, the checksum unit 440 can read the value stored in, for example, the checksum enable register 480 or one of the target registers 450₁-450_{N} to determine if the generation of checksum values is enabled. That is, the checksum unit 440 can determined whether to generate checksum values based on a value (e.g., enable bit value) stored in the checksum enable register 480 or one of the target registers 450₁-450_{N}.

At step 610, the checksum unit 440 determines which of the inputs received from the I/O unit 460 (e.g., address (ADDR), data (DATA), device address (DEVADDR), and/or port address (PORTADDR)) are to be utilized in the generation of the checksum.

For example, the checksum unit 440 can determine which of the various inputs are to be utilized in the generation of the checksum based on checksum mask information stored in one or more of the target registers 450₁-450_{N} and/or a checksum mask register 595. That is, the checksum mask information can be used to control which of the various inputs are included in (or excluded from) the generation of the checksum by the checksum unit 440.

After step 610, the flowchart 600 transitions to step 612, where the checksum unit 440 generates a checksum based on the included inputs determined in step 610 and a checksum value that is stored in, for example, the checksum register 490 or one or more of the target registers 450₁-450_{N}.

For example, the checksum unit 440 can read the checksum value stored in the checksum register 490, or in one or more of the target registers 450₁-450_{N}, and generate a new checksum value based on the read checksum value and the included inputs determined in step 610. The newly generated checksum value can then be stored in, for example, the checksum register 490 or one or more of the target registers 450₁-450_{N}. For the purpose of this discussion, the newly generated checksum value can overwrite any previously stored checksum value. However, it should be appreciated that the newly generated checksum value can be stored while retaining previously stored checksum values.

After step 612, the flowchart 600 transitions to step 614, where the checksum unit 440 determines if the generation of checksum values is enabled. If the checksum unit 440 determines that the generation of checksum values is enabled (YES at step 614), the flowchart 600 returns to step 606. Otherwise (NO at step 614), the flowchart 600 returns to step 604.

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

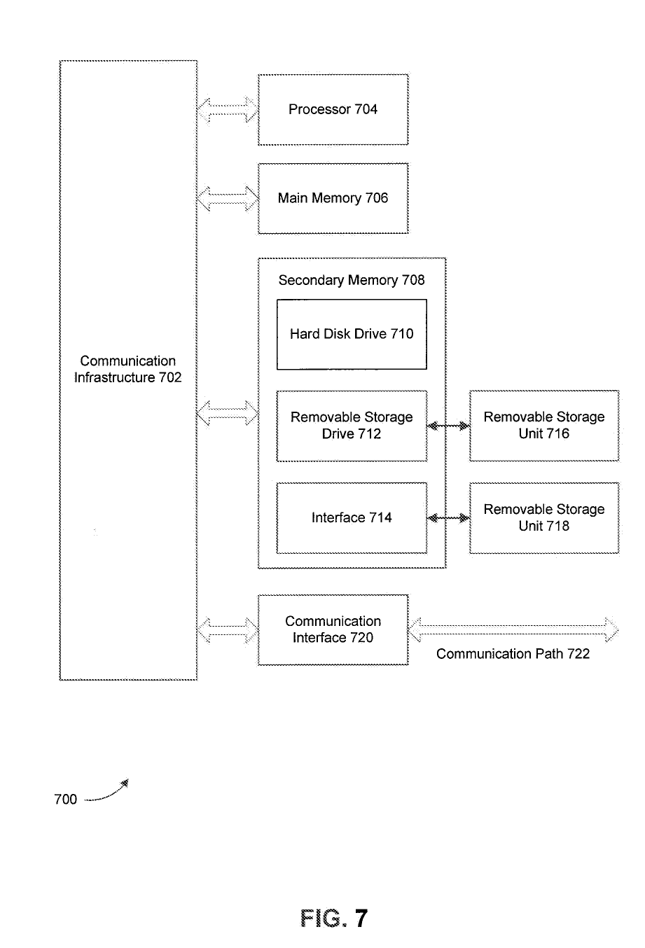

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 700 is shown in FIG. 7. At least some of the steps of the flowchart depicted in FIG. 6 can be implemented on one or more distinct computer systems 700, which can also represent at least portions of the station management entity (STA) 110 and/or MDIO manageable device 120.

Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the specification is not meant to limit the disclosure or the claims. Further, the scope of the invention is defined only in accordance with the following claims and their equivalents.

The forgoing Detailed Description of the exemplary embodiments has revealed the general nature of the present disclosure so that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

It will be apparent to those skilled in the relevant art(s) that various changes in form and detail can be made therein without departing from the spirit and scope of the present disclosure. Thus, the invention should not be limited by any of the above-described exemplary embodiments, but should be defined only in accordance with the following claims and their equivalents.

1. A method of data management utilizing a management data input/output (MDIO) protocol, comprising:
receiving a first MDIO frame via a MDIO protocol;
generating a first checksum value for the first MDIO frame;
receiving a second MDIO frame via the MDIO protocol:
selecting information from the received second MDIO frame; and
generating a second checksum value for the second MDIO frame based on the selected information and the first checksum value.

2. The method according to claim 1, wherein the information comprises:
an address block, a data block, a device address, or a port address.

3. The method according to claim 1, wherein the selecting of the information comprises:
selecting at least one of: an address block, a data block, a device address, and a port address.

4. The method according to claim 3, wherein the selecting of the information is based on checksum mask information.

5. The method according to claim 1, wherein the generating the first or the second checksum values utilizes cyclic redundancy check (CRC)

6. (canceled)

7. The method according to claim 1, further comprising:
storing the first checksum value in a target register of a MDIO manageable device.

8. The method according to claim 1, further comprising:
storing the first checksum value in a first register of a MDIO manageable device, wherein the first register is independent of a second register that is configured to store the received first MDIO frame.

9. The method according to claim 4, further comprising:
storing the checksum mask information in a target register of a MDIO manageable device.

10. The method according to claim 4, further comprising:
storing the checksum mask information in a first register of a MDIO manageable device, wherein the first register is independent of a second register that is configured to store the received first MDIO frame.

11. The method according to claim 1, further comprising:
determining a checksum enable bit value, wherein the generating the second checksum value is based on a comparison of the checksum enable bit value to a predetermined value.

12. The method according to claim 11, further comprising:
resetting the second checksum value based on the comparison of the checksum enable bit value to the predetermined value.

13. The method according to claim 1, further comprising:
resetting the second checksum value, based on a checksum enable bit value.

14. The method according to claim 11, further comprising:
storing the checksum enable bit value in a first register of a MDIO manageable device.

15. The method according to claim 11, further comprising:
storing the checksum enable bit value in a first register of a MDIO manageable device, wherein the first register is independent of a second register that is configured to store the received first MDIO frame.

16. A management data input/output (MDIO) manageable device, comprising:
an input/output (I/O) unit configured to:
receive a first address block, a first data block, a first device address, and a first port address via a MDIO protocol; and
receive a second address block, a second data block, a second device address, and a second port address via the MDIO protocol; and
a checksum unit configured to:
generate a first checksum value based on at least one of: the first address block, the first data block, the first device address, and the first port address;
select one or more of the second address block, the second data block, the second device address and the second port address, and
generate a second checksum value based on the selection and the first checksum value.

17. The MDIO manageable device according to claim 16, further comprising:
a plurality of target registers configured to store the first checksum value and the first data block.

18. The MDIO manageable device according to claim 16, further comprising:
a target register configured to store the first data block; and
a checksum register configured to store the first checksum value.

19. (canceled)

20. A management data input/output (MDIO) manageable device, comprising:
an input/output (I/O) unit configured to receive a first field of a first MDIO frame via a MDIO protocol, and to receive a second field of a second MDIO frame via the MDIO protocol;
a checksum unit configured to:
generate a first checksum value based on the first field of the first MDIO frame, and
generate a second checksum value based on the second field and the first checksum value.

21. The method according to claim 4, further comprising:
receiving the checksum mask information from a station management entity via the MDIO protocol.

22. The MDIO manageable device according to claim 16, wherein I/O unit is further configured to receive checksum mask information from a station management entity via the MDIO protocol; and wherein checksum unit is further configured to select the one or more of the second address block, the second data block, the second device address and the second port address based on the received checksum mask information.
